(19) United States
(12) Patent Application Publication
(10) Pub. No.: US 2015/0129698 A1
(43) Pub. Date: May 14, 2015

(54) PROCESSOR

(71) Applicants: Tyler Olson, Spring Valley, WI (US); Roger L. Olson, Nekoosa, WI (US)

(72) Inventors: Tyler Olson, Spring Valley, WI (US); Roger L. Olson, Nekoosa, WI (US)

(21) Appl. No.: 14/519,837

(22) Filed: Oct. 21, 2014

Related U.S. Application Data
(63) Continuation-in-part of application No. 13/274,921, filed on Oct. 17, 2011.
(60) Provisional application No. 61/470,681, filed on Apr. 1, 2011.

(51) Int. Cl. A01D 43/08; B02C 18/16

(52) U.S. Cl. CPC A01D 43/08; B02C 18/16
USPC 241/230

(57) ABSTRACT

A roll for use in processing crop materials in a crop processor apparatus is disclosed. The roll has a generally cylindrical cross-section and a plurality of alternating longitudinal ridges and longitudinal grooves on a surface of the roll. The longitudinal ridges having outer edges interrupted by gaps between the ends of the roll, forming tooth segments between the ends of the roll.

### CROSS-REFERENCE TO RELATED APPLICATIONS

This application claims priority to and is a Continuation-in-part of U.S. patent application Ser. No. 13/274,921, filed Oct. 17, 2011, entitled SYSTEM AND METHOD FOR PROCESSING CROPS MATERIALS INTO LIVESTOCK FEED AND THE PRODUCT THEREOF, which claims priority to U.S. Provisional Patent Application Ser. No. 61/470,681, filed Apr. 1, 2011, the contents of each of which is hereby incorporated by reference in its entirety herein.

### BACKGROUND

1. Field

The present disclosure relates to the production of livestock feed and more particularly pertains to a new system and method for processing crop materials into livestock feed for providing a feed that is more readily digested by livestock, such as ruminant animals, and that particularly provides fiber that is more effectively digested by the animal.

2. Description of the Prior Art

Crop materials may be harvested and processed to produce silage, and sometimes a forage harvester apparatus is used to harvest the crop materials from the field and perform some degree of processing of the crop materials in a manner that facilitates the formation of the silage before the materials are loaded into a storage container such as a silo or bag for fermentation. Typically, although not necessarily, the processing of the crop materials performed by the forage harvester includes cutting or chopping the crop materials into small pieces and crushing the crop materials to open the kernels present in the harvested materials.

Often the forage harvester includes a cutting or chopping stage and a processing stage. The apparatus of the chopping stage may include a drum or cutterhead that has a plurality of knives that are positioned in a spaced relationship along the circumference of the drum to cut the crop materials as the materials pass over a stationary shear bar inside the harvester. In many cases, the crop materials are cut into pieces that are relatively short, in the range of approximately 0.375 inches (approximately 9.5 mm) to approximately 0.75 inches (approximately 19 mm) long. The chopped crop material then moves to the apparatus of the processing stage which typically includes a pair of relatively closely spaced and generally cylindrical rolls with teeth that are intended to crush and open the kernels in the crop material to enhance the nutritional availability of the kernels in the resultant feed.

### SUMMARY

In view of the foregoing, the present disclosure describes a new system and method for processing crop materials into livestock feed which may be utilized to produce a feed that is more readily digested by livestock, such as ruminant animals, and that particularly provides fiber that is more effectively digested by the animal.

The present disclosure relates in one aspect to a method for processing crop materials to produce a feed product that provides the ingesting animal with a greater amount of available or effective fiber than using heretofore known methods of processing similar materials, and provides at least portions of the feed sp processed in a physical form that facilitates the natural ability of the animal to digest the fiber is a useful manner. A system is also disclosed that incorporates elements that provide the aspects of the method of producing the feed product.

In another aspect, the disclosure relates to a processor apparatus for processing crop materials into feed for livestock, with the processor apparatus being positionable in a forage harvester defining a path for moving crop materials cut from a field. The processor apparatus may comprise a housing for extending at least partially about the path of the crop materials, and at least two generally cylindrical rolls mounted on the housing. The rolls may be rotatable to move the crop materials through the housing, with a gap being formed between the rolls through which the path of the crop materials passes. At least one of the rolls may have a plurality of alternating longitudinal ridges and longitudinal grooves forming teeth on the surface of the roll. A rotating assembly may be configured to rotate the rolls with respect to the housing, the rotating assembly being configured to rotate the pair of rolls at different rotational speeds.

In still another aspect, the disclosure relates to a system for producing a feed product that may comprise a forage harvester defining a path for crop materials harvested from a field. The forage harvester may include a header apparatus for receiving and cutting plants in a field over which the harvester moves to thereby provide crop materials moved on the path through the harvester, with the crop materials comprising elements of the harvested plant, including plant stalks and kernels. The forage harvester may also include a chopper apparatus receiving crop materials on the path from the header apparatus, and the chopper apparatus may comprise a shear bar over which the crop materials from the header apparatus pass, with the shear bar having a cutting edge. The chopper apparatus may also comprise a rotating cutterhead having a plurality of knives mounted on the circumference of the cutterhead and being movable proximate to the cutting edge of the shear bar to cut crop materials passing over the shear bar. The cutterhead may be configured to cut plant stalks of the crop materials to lengths of approximately 1 inch to approximately 2.5 inches.

In yet another aspect, the disclosure relates to a method of producing feed for animals that may comprise cutting plants growing in a field by a header apparatus and placing the plants as crop materials on a path through a forage harvester, chopping the plants of the crop materials in a manner to produce pieces of the plants that have lengths of approximately 1 inch to approximately 2.5 inches long, and processing the plant pieces of the crop materials between rolls of a processor apparatus rotating at a speed differential of at least 10 percent.

The disclosure also relates to feed produced using the disclosure.

There has thus been outlined, rather broadly, some of the more important elements of the disclosure in order that the detailed description thereof that follows may be better understood, and in order that the present contribution to the art may be better appreciated. There are additional elements of the disclosure that will be described hereinafter and which will form the subject matter of the claims appended hereto.

In this respect, before explaining at least one embodiment or implementation in greater detail, it is to be understood that the scope of the disclosure is not limited in its application to the details of construction and to the arrangements of the components of the systems, and the particulars of the steps of the methods, set forth in the following description or illustrated in the drawings. The disclosure is capable of other embodiments and implementations and is thus capable of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present disclosure. It is important, therefore, that the claims be regarded as including such equivalent constructions insofar as they do not depart from the spirit and scope of the present disclosure.

The advantages of the various embodiments of the present disclosure, along with the various features of novelty that characterize the disclosure, are disclosed in the following descriptive matter and accompanying drawings.

### BRIEF DESCRIPTION OF THE DRAWINGS

The disclosure will be better understood and when consideration is given to the drawings and the detailed description which follows. Such description makes reference to the annexed drawings wherein:

FIG. 1 is a schematic diagram of a new system for processing crop materials into livestock feed according to the present disclosure.

FIG. 2 is a schematic side sectional view of a processor apparatus, according to an illustrative embodiment.

FIG. 3 is a schematic perspective view of one highly suitable processer roll design for use with the present disclosure.

FIG. 4 is a schematic side view of the processer roll design shown in FIG. 3.

FIG. 5 is a schematic enlarged view of a portion of the side view of FIG. 4.

FIG. 6 is a schematic longitudinal sectional view of the processor roll of FIG. 4 taken along line 6-6 of FIG. 4.

FIG. 7 is a schematic end view of the processor roll shown in FIG. 3.

FIG. 8 is a schematic flow diagram of a method according to the present disclosure.

FIG. 9 is a view of a processor apparatus in accordance with example embodiments.

FIG. 10 is an exploded view of the processor apparatus in accordance with example embodiments.

FIGS. 11A-11D are views of an end member in accordance with example embodiments.

FIGS. 12A-12D are views of a gap adjustment device in accordance with example embodiments.

FIG. 13 is a view of an attachment member in accordance with example embodiments.

FIGS. 14A-14C are views of a first wedge member in accordance with example embodiments.

FIGS. 15A-158 are views of a second wedge member in accordance with example embodiment.

FIGS. 16A-16D are views of a biasing member in accordance with example embodiments.

FIG. 17 is a view of a cross member in accordance with example embodiments.

FIG. 18 is a view of a cross member in accordance with example embodiments.

FIG. 19 is a view of a cross member in accordance with example embodiments.

FIG. 20 is a view of a cross member in accordance with example embodiments.

FIGS. 21A-21D are section views of the processing apparatus in accordance with example embodiments.

FIG. 22 is a section view of the processing apparatus in accordance with example embodiments.

### DETAILED DESCRIPTION

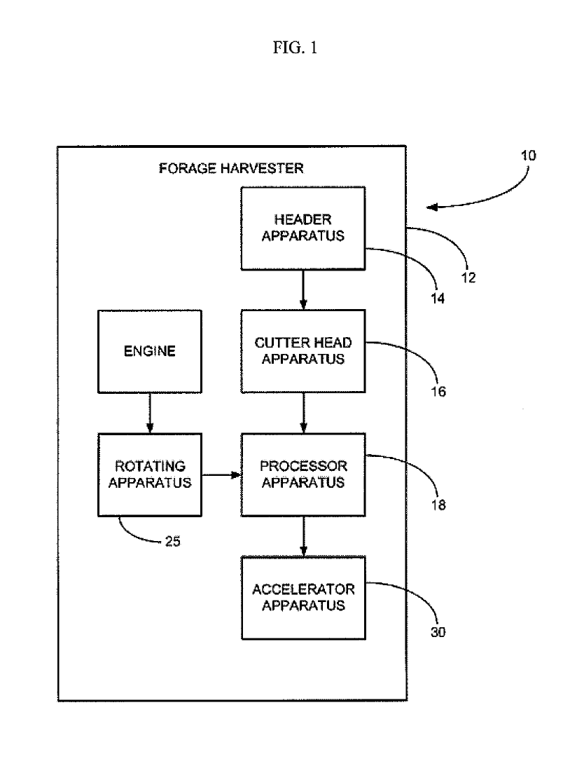

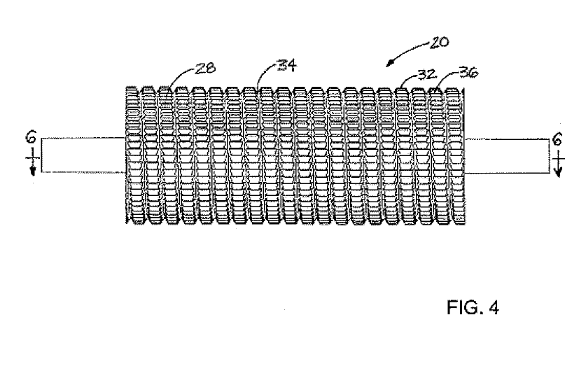

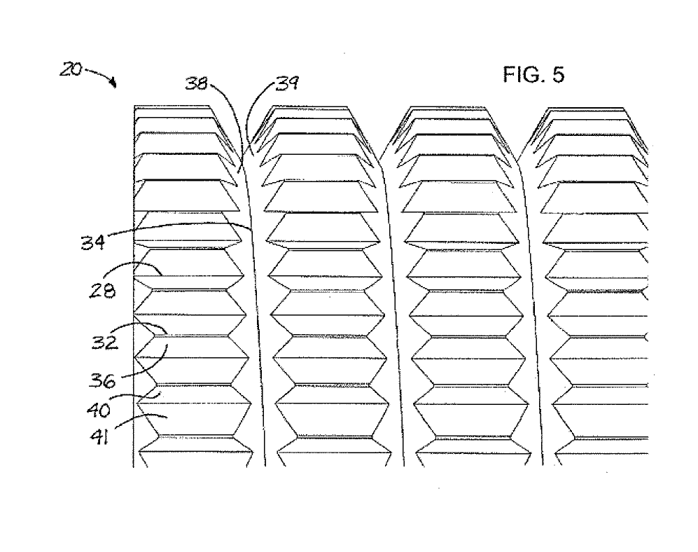

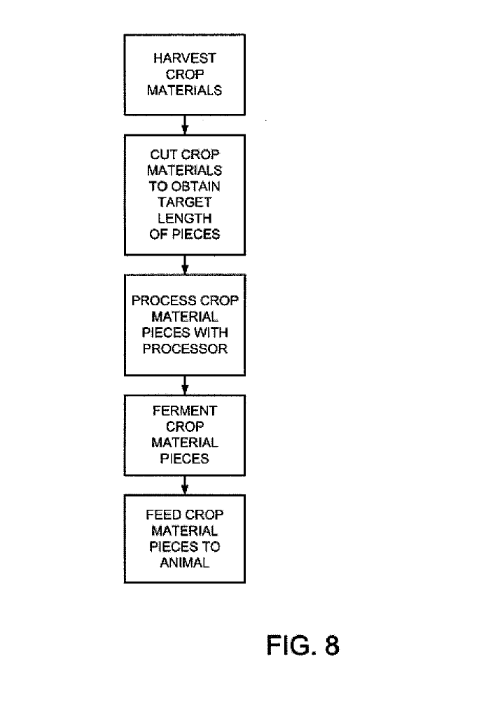

With reference now to the drawings, and in particular to FIGS. 1 through 8 thereof, a new system and method for processing crop materials into livestock feed embodying the principles and concepts of the disclosed subject matter will be described.

Broadly, the disclosure is generally directed to modifications of conventional silage chopping and processing apparatus and methods for producing a silage product that is more suitable for digestion by livestock, and in particular animals having rumen-based digestive systems, such as cattle. While heretofore the focus of the chopping and processing of the crop materials has been on breaking up the kernels and cobs of the crop materials, the system and method of the present disclosure additionally focuses upon the form of the plant stalks, and in particular the size and character of the plant stalk pieces that are produced, to increase the nutritional value of the stalk pieces to the ingesting animals. In particular, the degree to which the fiber of the plant stalks may be effectively digested by the animal is enhanced.

A system 10 with suitable elements for producing a feed product with the desired characteristics may include a forage harvester 12 that may include a header apparatus 14 for cutting the plants in the field over which the harvester 12 is moving to thereby provide the crop materials that are moved through the harvester. The form of the header apparatus 14 is typically designed for the harvesting of a particular type of crop being harvested, but will not be further described herein. Once cut from the ground in the field, the crop materials may include the various elements of the harvested plant, such as the plant stalk, leaves, kernels, cobs, as well as other plant matter.

The crop materials are moved from the header apparatus 14 through the harvester 12 to a chopper apparatus 16 that typically includes a rotating cutterhead or drum that includes a plurality of blades or knives mounted on the circumference of the drum to cut or chop the crop materials passing over a shear bar. The knives are spaced along the circumference of the cutterhead so that a knife passes across the shear bar at intervals as the crop materials pass over the shear bar. Cutterheads or drums that are suitable for modifying for the disclosed system are known, as well as suitable shear bar designs.

The chopped crop materials are then moved to a processor apparatus 18 that includes two generally cylindrical rolls 20, 22 in a housing 24, and a rotating assembly 25 may be utilized to rotate the rolls with respect to the housing. The rotating assembly 25 typically receives rotational input from the engine of the harvester through, for example, a series of belts, chains or gears, but could include a dedicated motor for rotating the rolls substantially directly. The rotating rolls move the materials through the housing of the processor. One or both of the processor rolls has a plurality of alternating ridges 26 and grooves 28 that form teeth on the surface of the roll. The crop materials may then pass through an accelerator apparatus 30 to facilitate movement through the harvester, although the presence of an accelerator is not critical to the systems and methods of the disclosure.

Applicants have determined that conventional silage processing apparatus and methods are primarily directed to maximizing the percentage of kernels of the crop materials that are opened by passing through the kernel processor apparatus of the forage harvester employed to gather and process the crop materials, but that efforts focusing solely on the task of kernel opening tend to produce pieces of the plant stalk that are difficult to digest by livestock having rumen-based digestive systems. The efforts to create systems that more effectively crush the kernels may thus be counter-productive to the goal of producing better digestion of the feed by the animal by making the stalks of the plant, and particularly the fiber thereof, less digestible by the animal.

Applicants have recognized that the conventional chopping and processing apparatus configurations, primarily designed for maximum kernel rupture, tend to over process the stalk pieces by crushing the pieces, and the crushed stalk pieces tend to make the fiber of the stalk less available to be digested by the animal, and thereby providing less effective fiber for the animal's nutrition. As a result, in addition to the processed crop materials (e.g., in the form of silage) fed to the animal, supplemental feed may also need to be fed to make up for the fiber that is present in the stalk pieces but not effectively digested by the animal's digestive process.

For example, to achieve greater kernel opening effectiveness, the substantially cylindrical rolls of the processor apparatus have been moved closer together in order to maximize the percentage of the kernels in the crop materials that are fractured or ruptured as the materials pass between the rolls. Applicants have determined that, as a result of moving the rolls of the kernel processor very close together, the stalks of the crop materials have been ground or crushed into a form that, when ingested by ruminant animal, tends to settle relatively quickly to the bottom of the chamber or chambers of the ruminant animal's digestive system. Thus, the crushing of the stalk pieces in turn tends to interfere with the ability and effectiveness of the animal's digestive system to digest the fiber in the plant stalks, making the fiber in the stalks less available and thus less beneficial to the animal, and can lead to ill effects on the animal beyond the loss of the nutritive value of the fiber.

Applicants have recognized that it would be desirable to develop and utilize a system and method which produces silage that not only maximizes the number of kernels that are opened, but that also provides plant stalk pieces that have fiber in a form that is more effective and suited to the digestion process of the animal. Applicants have determined that a product that is more digestible may be produced by controlling one or more of a number of factors or parameters of the harvesting and processing process that are different and foreign to the conventional manner of harvesting and processing the forage plants. This new system and method produces a new feed product that includes plant stalks that have a physical form that is markedly different from the form of plant stalks from crop materials that are harvested and processed in the conventional manner. Thus, using the same crop materials as an input, a feed product with more digestible fiber may be produced by controlling select parameters of the chopping and processing of the materials.

In some implementations, the feed product has stalk pieces with a physical form that may be characterized by being relatively flattened from the characteristic generally cylindrical shape of the stalk pieces in the unprocessed form. The stalk pieces may be generally split in a lengthwise direction, and the fibers of the stalk pieces in the product tend to be torn from each other so that some fibers of the stalk piece remain together in a group, but the fibers may be thinly connected to each other or to the fibers of other groups. The processed stalk piece of the product may thus be separated into two or more collections of the fibers of the plant, with some fibers connecting the collections together. The constituent fibers of the stalk piece may thus be at least partially torn from each other, although groups of the fibers may remain connected together despite the tearing that has occurred. The collections of fibers from the split stalk piece may form a structure with a mat-like appearance.

The stalk pieces with the general physical form and characteristics disclosed herein may provide more effective fiber to the ingesting animal by increasing the amount of surface area of the plant stalk that is exposed to the digestive fluids and microbes of the animal's digestive tract and therefore increases the ability of the digestive fluids to contact and act upon the plant stalk fibers. These elements of the animal's digestive tract are thus able to act more effectively upon the ingested fiber. For example, the relatively higher amount of surface area increases the extent of the plant stalk fibers exposed to the microbes for being acted upon by the microbes inhabiting the gut of the animal. Further, the plant stalk pieces of the form described herein may descend more slowly through the digestive fluids in the pouches of the digestive tract, which facilitates the action of the fluids and microbes on the plant stalk fibers. Slowing the passage rate of the fibers through the tract increases the time that the fibers are exposed to the fluids and microbes in the tract and thus the time that these elements are able to act upon the fibers. This characteristic is in contrast to stalk fibers processed by more conventional methods, which present a fairly compact crushed mass with less surface area for the digestive fluids to act upon, and are also relatively quicker to descend to the lower reaches of the compartments of the gut of the ingesting animal which may reduce the time that the digestive fluids and microbes have to act upon the fibers.

The applicants have found that one significant parameter of the harvesting and processing of the crop materials is the length of the pieces into which the plants of the crop materials, and in particular the plant stalks, are chopped or cut before further processing. For the purposes of this disclosure, the length of the pieces is generally measured in a direction parallel to the longitudinal length of the uncut plant stalk. Generally, the length represents a maximum length that is produced by the procession, as some pieces of shorter lengths are also likely to be produced by the disclosed systems and processes, and some pieces of longer lengths may also be produced, but in significantly smaller percentages of the total mass of plant stalks cut.

In some implementations, pieces of the plant stalks produced by the systems and methods of the disclosure may have lengths in the range of approximately 1 inch (approximately 26 mm) to approximately 2.5 inches (approximately 60 mm), while being relatively finely ground in thickness. In some further implementations, the fibers of the stalks of the processed crop materials may have lengths in the range of approximately 1.25 inches (approximately 32 mm) to approximately 1.5 inches (approximately 38 mm). The preferred piece lengths are in contrast to the length of plant stalk fibers produced by conventional forage harvester set ups that generally have fiber lengths of approximately 0.375 inches (approximately 9.5 mm) to approximately 0.75 inches (approximately 19 mm) long.

To provide stalk pieces with lengths that are generally longer than conventionally utilized, in some implementations of the system the circumferential separation or spacing between the blades of the drum of the chopper apparatus of the forage harvester is increased. In some embodiments of the chopping apparatus, the increase in circumferential separation distance may be produced by removing alternate blades from the drum of the chopper to effectively generally double the length of the cut pieces as compared to what would have been produced otherwise. It will be appreciated that other suitable manners of forming the longer stalk piece lengths may be utilized.

Cutting the crop materials, and in particular the plant stalks, into longer pieces than conventional, may change the manner in which the stalk pieces are handled by the processor and the physical form of the pieces output by the processor. The cut stalk pieces with the longer length tend to be processed by a processor apparatus in a manner that is different from pieces that have a shorter length, and as a result tend to exit the processor in a form that is different than when the pieces have a shorter length. More specifically, the stalk pieces with longer lengths tend to travel through the processor with their longest axis oriented substantially parallel to the direction that the pieces are moving through the processor. This movement orientation tends to cause an end of the stalk piece to enter the processor and pass between the processor rolls, first with an initial or forward end and then the remainder of the piece follows with the end opposite the initial end, or rearward end, passing between the rolls last. The movement of the piece in a longitudinal manner through the processor tends to produce pieces of plant stalk that are split into pieces in the length wise direction, or parallel to the longitudinal length of the plant stalk piece. Thus, the plant stalk pieces have approximately the same length after being processed than before being processed using the systems and processes of the disclosure and are not compressed lengthwise. This lengthwise movement may at least partially contribute to the physical form of the processed stalk pieces that is described herein for the feed product. It will be appreciated that the increase in the length of the stalk pieces produced by the chopper does not affect the degree to which the kernels are opened by the processor.

Another parameter that may be effective in producing the desired physical form or character of the processed plant stalks is the spacing of the rolls from each other. Generally, the axis of rotation of the rolls of the processor apparatus are substantially parallel to each other, and the rolls are spaced from each other to form a gap therebetween that is substantially uniform in width along the length of the rolls. The size of the gap may also contribute to the degree to which the fibers of the stalk pieces are torn from each other, particularly where the stalk pieces move through the gap with the longitudinal axis of the pieces aligned with the direction of movement of the pieces. Further, the relative closeness of the rolls contributes to the beneficial flattening of the stalk pieces without excessive crushing of the pieces. While the closeness of the rolls may tend to crush stalk pieces with shorter lengths into a less digestible mass of fiber, the relatively longer length of the stalk pieces of the disclosure tend to resist crushing as the fibers are pulled apart rather than staying together, particularly in the context of the other parameters of the processor disclosed herein. In some implementations of the system and method, the spacing of the rolls with respect to each other, and thus the gap (G) therebetween, may be in the range of approximately 0.01 inches (approximately 0.25 mm) to approximately 0.1 inches (approximately 3 mm), which is highly preferable for obtaining the desired character of the stalk pieces, as well as ensuring that a large percentage of the kernels present in the crop materials are crushed, although other spacings may also be used. As will be described below, other characteristics of the system may affect the suitable range of roll spacings.

The employment of rolls in the processor apparatus that have relatively larger diameters provides a greater surface area of the roll that is in contact with the crop materials moving between the rolls at any one time. The greater surface area in contact with the stalks may result in a longer time period of contact with the stalks, and a longer time for the roll to act on the stalk to provide a greater chance for and degree of tearing the stalk into constituent fibers or groups of fibers. The relatively larger diameter of the rolls also reduces the pinch angle between the crop materials moving between the rolls and the surface of the rolls, which may reduce crushing of the stalk pieces. The increased roll diameter may also provide greater consistency or uniformity in the physical form of the crop materials passing out of the processor apparatus.

As an additional benefit, the relatively larger diameter of the rolls allows the rolls to rotate at a slower rotational speed that produces substantially the same speed of movement of the surface of the roll, and thus the same speed of movement of the crop materials through the processor, but the slower rotational speed reduces wear on the components of the processor apparatus.

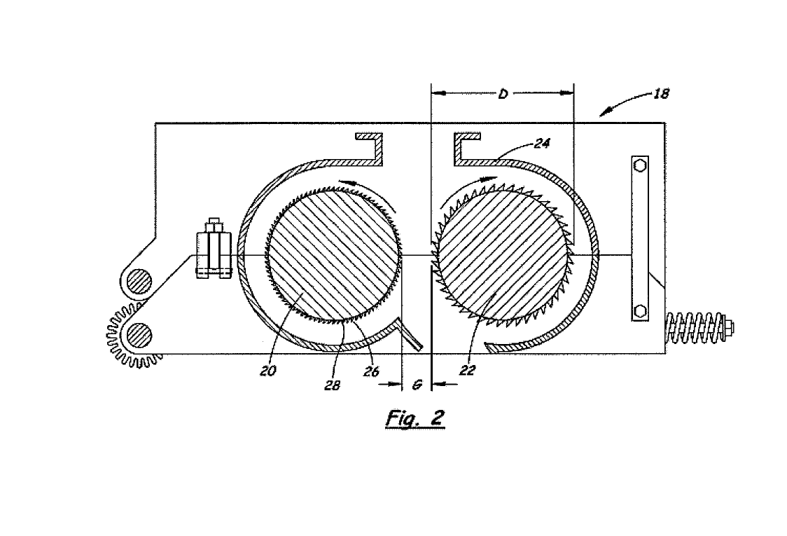

Another parameter of the system and process that may contribute to the character of the stalk pieces in the output of the processor is the character of the surface of the rolls, and the grooves or grooving formed on the surface of at least one of the rolls, and in many preferred embodiments, grooving formed on the surfaces of both of the rolls, of the processor apparatus. The grooves on the roll surface form teeth-like projections formed by alternating grooves and ridges on the surface that extend in a generally longitudinal direction on the roll and may extend from one end of the roll to the other end of the roll. In some of the most preferred embodiments, the teeth-like projections have a cross sectional shape similar to a saw-tooth, and in some further embodiments, the saw-tooth-shaped teeth of one roll may be oriented oppositely to the saw-tooth-shaped teeth of the other roll (see FIG. 2). The density of ridges or teeth on a roll may be defined as the number of ridges per distance measured along the circumference of the roll, such as ridges or teeth per inch of circumference. The size and density of the teeth may be approximately 3 ridges or teeth per inch (approximately 1.2 teeth per cm) to approximately 8 teeth per inch (approximately 3.2 teeth per cm), and while this tooth size and density is highly preferable, other sizes and densities for the teeth may be employed. This range of ridge or tooth density, and the resulting tooth size, may contribute to the tearing of the fibers of the plant stalk material away from each other, particularly in combination with the longer time of contact between the larger rolls and the stalks of the crop materials.

Another parameter of the system that may contribute to the desired character of the stalk pieces is the difference or differential in the rotational speeds of the rolls as the crop material passes therebetween, as a difference in the rotational speeds of the rolls further contributes to the tearing of the fibers of the stalk from each other. A higher or greater differential between rotational speeds is believed to increase the tearing of the fibers of the stalk from each other and produce the desired physical form described herein that enhances the availability of the fiber to the digestive system of the animal. In many preferred implementations, the rotational speed differential is between approximately 10 percent and approximately 200 percent, so that, with respect to the rotational speed of one roll, the rotational speed of the other roll may be approximately 10 percent faster to approximately 200 percent faster.

Another parameter that may be effective in producing the desired physical form or character of the processed plant stalks is the spacing of the rolls from each other. Generally, the axes of rotation of the rolls of the processor apparatus are substantially parallel to each other, and the rolls are spaced from each other to form a gap therebetween that is substantially uniform in width along the length of the rolls. The size of the gap may also contribute to the degree to which the fibers of the stalk pieces are torn from each other, particularly where the stalk pieces move through the gap with the longitudinal axis of the pieces aligned with the direction of movement of the pieces. Further, the relative closeness of the rolls contributes to the beneficial flattening of the stalk pieces without excessive crushing of the pieces. While the closeness of the rolls may tend to crush stalk pieces with shorter lengths into a less digestible mass of fiber, the relatively longer length of the stalk pieces of the disclosure tend to resist crushing as the fibers are pulled apart rather than staying together, particularly in the context of the other parameters of the processor disclosed herein. In some implementations of the system and method, the spacing of the rolls with respect to each other, and thus the gap (G) therebetween, may be in the range of approximately 0.01 inches (approximately 0.25 mm) to approximately 0.1 inches (approximately 3 mm), which is highly preferable for obtaining the desired character of the stalk pieces, as well as ensuring that a large percentage of the kernels present in the crop materials are crushed, although other spacings may also be used. As will be described below, other characteristics of the system may affect the suitable range of roll spacings.

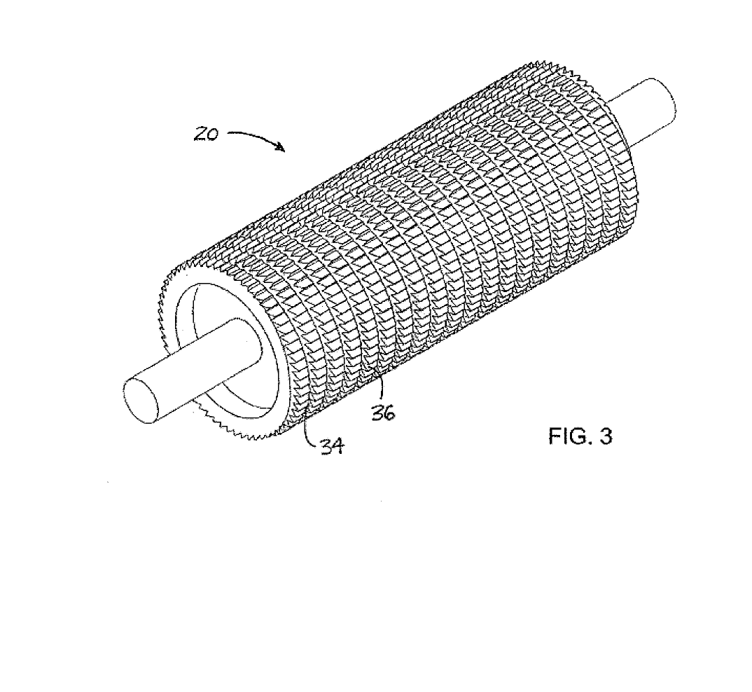

Another characteristic of the rolls that may provide more effective shredding of the plant stalk material is the character of the ridges 26 that form the teeth-like projections between the longitudinally-extending grooves 28. In many embodiments of the rolls, the ridges 26 extend for the entire, or substantially the entire, length of the roll between the ends of the roll where the mounting shafts extend from the roll. In some further embodiments, the outer edges 32 of the ridges (which form the primary contact point for the materials being processed) may be continuous along a line that extends substantially from one end of the roll to the other. In other embodiments, the outer edges 32 of the ridges 26 may be interrupted by gaps and thus the outer edge of the ridge may be intermittent or segmented between the ends of the roll. As shown in FIGS. 3 through 7, one or both of the pair of rolls 20, 22 of the processor may have one or more circumferential grooves 34 formed in the roll that cross the longitudinally-extending ridges 26 and grooves 28. For example, the circumferential groove 34 may be formed in the circumference of the roll along a helical path that intersects and cuts across the ridges of the roll that are formed or defined by the longitudinally-extending grooves 28. In other embodiments, a series of circular circumferential grooves may be formed between the ends of the roll at uniform or non-uniform spacings with respect to each other. The circumferential groove 34 or grooves may have a depth that is greater than the depth of the longitudinally-extending grooves 28, although this is not critical. The circumferential grooves 34 may form segmented teeth 36 on the outer edges 32 of the ridges 26 that improve the ability of the roll to produce the desired shredding of the plant stalks into pieces of the desired character.

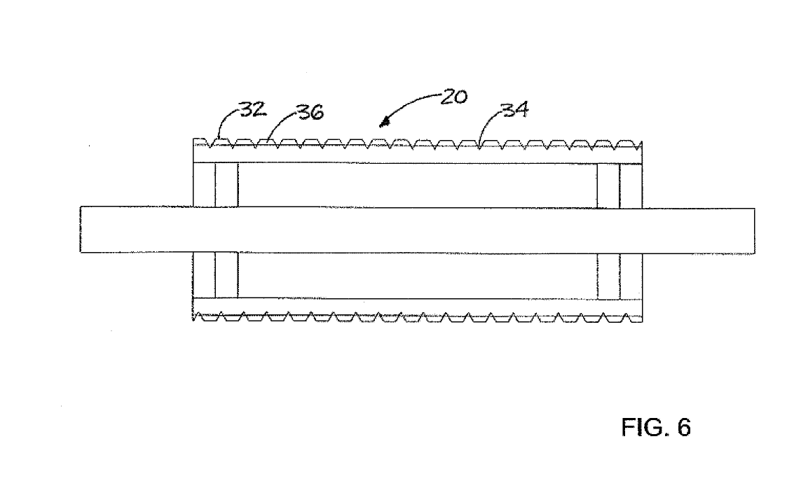

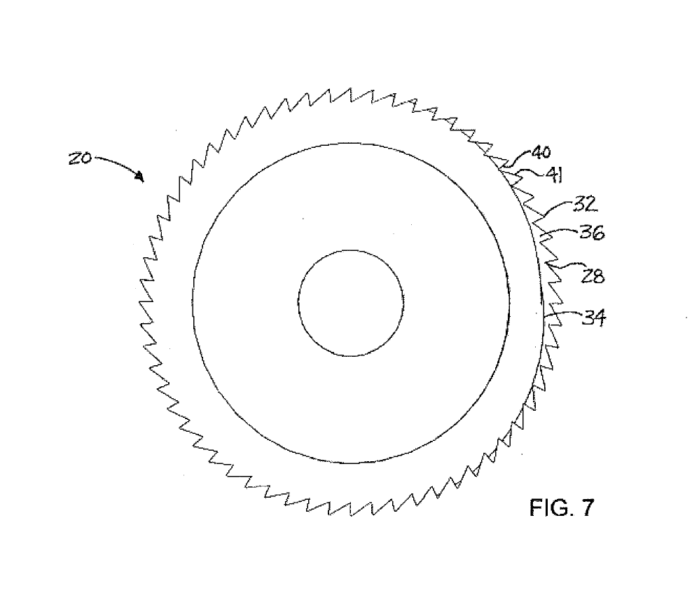

The teeth 36 that are formed by the combination of the longitudinally-extending and circumferential grooves may have outer edges that are short linear edges, or lands, that extend in a longitudinal direction of the roll. Illustratively, the profile of a tooth may have a truncated pyramid shape in a longitudinal cross section (see FIG. 6) and may have a full (or substantially full) pyramid shape in a lateral cross section (see FIG. 7). In some embodiments, the circumferential grooves 34 may be substantially V-shaped, and the side surfaces 38, 39 of the groove may be substantially identical in size and shape, although this is not critical, and some truncation of the bottom of the V-shaped groove may be utilized. In some embodiments, the longitudinally-extending grooves 28 may have a configuration in which the side surfaces 40, 41 are not substantially identical, and one side surface 41 may be larger than the other side surface 40 such that the teeth appear to lean or lead toward one circumferential direction and away from the opposite circumferential direction.

In some embodiments, the longitudinal lengths of the tooth segments or teeth 36 are less than approximately 1 inch (approximately 2.5 cm), and in some other embodiments the longitudinal lengths of the segments may be from approximately 0.125 inches (approximately 0.3 cm) to approximately 0.75 inches (approximately 2 cm). Further, in some embodiments the depth of the circumferential groove or grooves (as measured from the outermost extent of the ridges) is less than approximately 0.5 inches (approximately 1.3 cm) and may be from approximately 0.02 inches (approximately 0.05 cm) to approximately 0.25 inches (approximately 0.65 cm). Further, some embodiments of the rolls may have V-shaped circumferential grooves 34 that range from approximately 30 degrees to approximately 120 degrees between the side surfaces 38, 39 of the groove, and in some embodiments may be from approximately 40 degrees to approximately 100 degrees between the side surfaces of the groove.

Rolls that include the circumferential grooves have relatively shorter outer edges on the lands of the teeth 36 that facilitate the penetration of the tooth into the plant stalk as compared to rolls having longer lands such as on a ridge that is continuous between the roll ends. The relatively smaller outer edge 32 of the land is able to tear the stalk apart as a land on the opposite roll pierces the stalk from substantially the opposite direction. As a result of the easier penetration and more effective tearing provided by the shorter lands, less pressure is needed to be exerted by the rolls against the plant stalks and the rolls of the processor can be spaced further apart from each other while still providing an effective level of tearing and shredding of the plant stalk. Consequently, the relatively larger gap between the rolls may require less power to drive the rolls because the crop material is not crushed to as great a degree before it is shredded. Also, the wider roll gap imposes less stress on the rolls, and thus the teeth of the roll tend to remain sharp for a longer period, which results in less cost to the user for roll maintenance and replacement. The relatively wider gap between rolls also allows the processor to operate more quietly due to less air turbulence being created between the rolls. Also, greater throughput is achieved using the wider gap, allowing the harvester to move at a faster rate through the field at harvest.

Illustratively, a pair of rolls lacking the circumferential groove may have a gap therebetween of approximately 0.04 inches (approximately 1 mm) to approximately 0.08 inches (approximately 2 mm), and a pair of rolls having the circumferential groove may have a gap therebetween of approximately 0.12 inches (approximately 3 mm) and approximately 0.24 inches (approximately 6 mm) and in some of the more preferred embodiments, a gap of approximately 0.14 inches (approximately 3.5 mm) to approximately 0.22 inches (approximately 5.5. mm).

Even with the wider gap, the combination of coarse and fine rolls operated together, with the short lands at a suitable spacing between each other, help to ensure that the kernels of the crop materials are also ground into pieces as the plant stalks are torn and shredded.

Applicants have recognized that processing the crop materials in the manner of the present disclosure, and particularly with relatively longer length of the stalk pieces, tends to be more difficult to process by the processor apparatus of the forage harvester, and stronger and more durable components may need to be employed in the processor apparatus. Further, as the rolls of the processor are spring biased toward each other, the biasing force applied to the rolls may need to be increased, and the biasing elements, such as springs, may need to be strengthened as compared to conventional processors.

In another aspect, the disclosure includes methods of processing crop materials including the plant materials using various aspects disclosed or suggested herein to provide a feed that is highly suitable for digestion by ruminant animals. The method may include, for example, cutting plants that are growing in a field by using a header apparatus and placing the plants of the crop materials on a path through a forage harvester, and chopping the plants of the crop materials in a manner disclosed that produces pieces of the plants that have the lengths disclosed, and processing the plant pieces between rolls of a processor apparatus rotating at a speed differential to facilitate the tearing of the plant materials of at least 10 percent.

In still another aspect, the disclosure includes the feed produced by the systems and apparatus having the various aspects disclosed or suggested herein, and by methods including the various aspects of handling also disclosed or suggested herein.

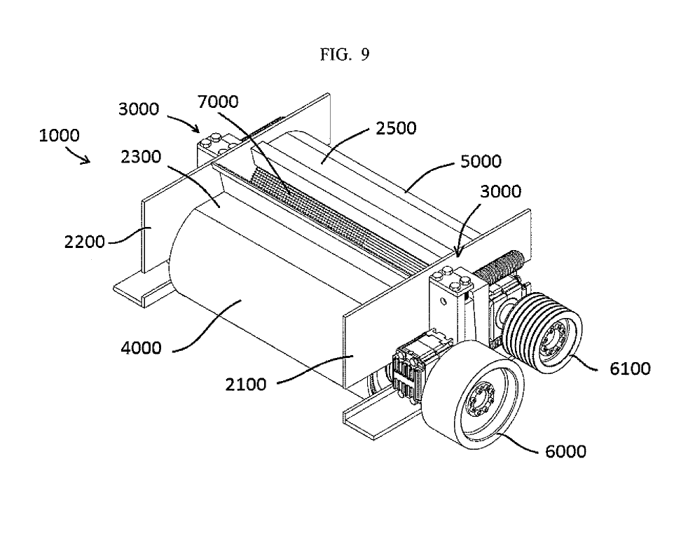

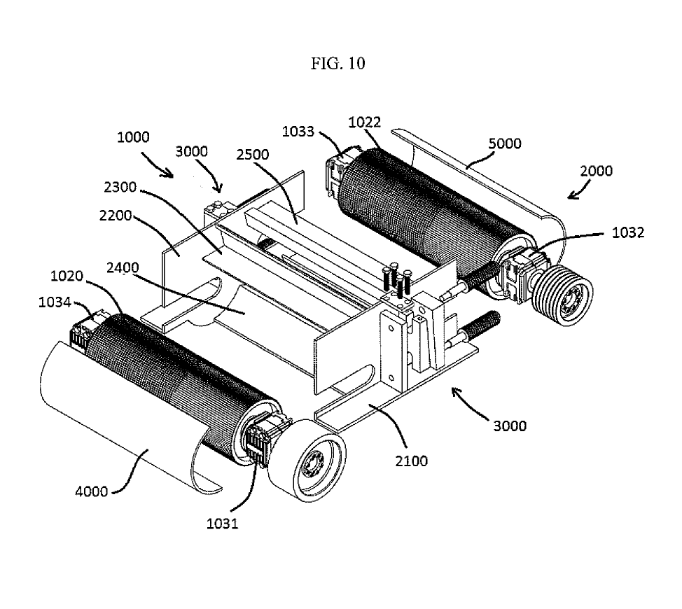

FIG. 9 is a view of a processor apparatus 1000 in accordance with example embodiments. FIG. 10 is an exploded view of the example processor apparatus 1000. In example embodiments the processor apparatus 1000 may be installed in a machine, for example, a forage harvester, to process a material, for example, chopped corn stalks. As such, the processor apparatus 1000 may be usable as the processor apparatus 18 illustrated in FIG. 1. Accordingly, the processor apparatus 1000 may be configured and/or controlled to accomplish and/or achieve any of the requirements set forth above.

As shown in FIGS. 9 and 10, the processor apparatus 1000 may include a first cylindrical roll 1020 and a second cylindrical roll 1022 spaced apart from one another so as to form the gap G there between. In example embodiments, a shaft of the first cylindrical roll 1020 may be supported by bearings 1031 and 1034 and a shaft of the second cylindrical roll 1022 may be supported by bearings 1032 and 1033. In example embodiments the bearings 1031, 1032, 1033, and 1034 may be directly or indirectly connected to a frame 2000 as shown in at least FIGS. 9 and 10. In example embodiments, the first cylindrical roll 1020 and the second cylindrical roll 1022 may be substantially identical to the first roll 20 and the second roll 22 (or any of the previously described rolls), thus, a detailed description thereof is omitted for the sake of brevity. Furthermore, the first and second cylindrical rolls 1020 and 1022 may be operated in a manner consistent with the previously described rolls. For example, in operation they may rotate at different speeds, have different cutting teeth, and have different sizes.

In example embodiments the processor apparatus 1000 may further include a pair of gap adjustment devices 3000. In example embodiments, the gap adjustment devices 3000 may be configured to adjust the gap G between the first and second cylindrical rolls 1020 and 1022. For example, in example embodiments the gap adjustment devices 3000 may create a spacing between the first and second cylindrical rolls 1020 and 1022 in a range of about 0.01 inches (approximately 0.25 inches) to approximately 0.1 inches (approximately 3 mm), however, the gap adjustment devices 3000 may be configured to provide smaller gaps than 0.01 inches or larger gaps than 0.1 inches. As explained above, the gap G provides a space in which cut materials may be processed by the first and second cylindrical rolls 1020 and 1022.

As shown in FIGS. 9 and 10, the frame 2000 may include a first end member 2100 and a second end member 2200 connected to one another by a plurality of connecting members. For example, in example embodiments the plurality of connecting members may include a first connecting member 2300, a second connecting member 2400, a third connecting member 2500, and a fourth connecting member 2600 each of which may connect the first end member 2100 to the second end member 2200. Although the example processor apparatus 1000 is illustrated as including four connecting members 2300, 2400, 2500, and 2600 example embodiments are not limited thereto as there may be more than four connecting members or less than four connecting members connecting the first end member 2100 to the second end member 2200. As such, the number of connecting members is not intended to be a limiting feature of example embodiments.

In example embodiments the first and second end members 2100 and 2200 may be substantially identical to each other (or mirror images of each other), thus, only a description of the first end member 2100 is provided for the sake of brevity. It is pointed out, however, that example embodiments do not require the first and second end members 2100 and 2200 be identical to each other as the first and second end members 2100 and 2200 may be different from one another.

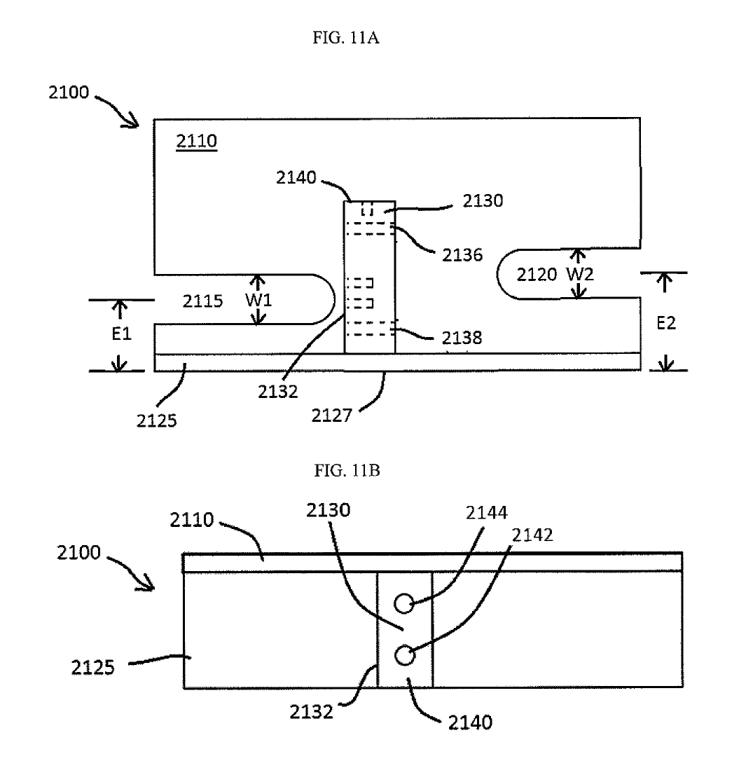

FIG. 11A is an elevation view of the first end member 2100, FIG. 11B is a top view of the first end member 2100, FIG. 11C is a first side view of the first end member 2100, and FIG. 11D is a second side view of the first end member 2100. Referring to FIGS. 11A-11D it is observed that the first end member 2100 may include a main member 2110 which may resemble a substantially flat plate. It is understood, however, the main member 2110 is not limited to a flat plate shaped member and that the main member 2110 may resemble another structure such as a curved plate or some other structure such as, but not limited to, a built up member.

As shown in FIGS. 11A-11D, the first end member 2100 may include a first slot 2115 and a second slot 2120. In example embodiments, the first slot 2115 and the second slot 2120 may be configured to have widths large enough to accommodate support shafts of the first and second cylindrical rolls 1020 and 1022. For example, in the event the shaft of the first cylindrical roll 1020 has a diameter of about 3 inches, the width W1 of the first slot 2115 may be about 3 1/16 inches. As another example, in the event a shaft of the second cylindrical roll 1022 has diameter of 2 inches the width W2 of the second slot 2120 may be about 2⅛ inches. Although specific dimensions have been provided for the widths W1 and W2 of the slots 2115 and 2120, these dimensions are merely exemplary and are not intended to limit the invention as the widths W1 and W2 may depart from the dimensions described above. Furthermore, the slots 2115 and 2120 are not required to have a constant width and may, instead, have a variable width. Similarly, although specific examples of the diameters of the first and second cylindrical rolls 1020 and 1022 have been provided as 3 inches and 2 inches, these dimensions are merely for the purpose of illustration and are not meant to limit example embodiments since the diameters of the shafts of the first and second cylindrical rolls 1020 and 1022 may be different from 2 and/or 3 inches. Furthermore, the diameter of the shafts of the first and second cylindrical rolls 1020 and 1022 are not required to be different and, in fact, may have the same diameters, as such, widths W1 and W2 may also be the same.

Referring to FIG. 11A it is noted that the first and second slots 2115 and 2120 may have different elevations with respect to a bottom 2127 of the first end member 2100. For example, a centerline of the first slot 2115 may be spaced a first distance E1 from the bottom 2127 of the first end member 2100 and the second slot 2120 may be spaced a second distance E2 from the bottom 2127 of the first end member 2100. In the particular example of FIGS. 11A-11D the first distance E1 may be smaller than the second distance E2. This however, is not meant to be a limiting feature of example embodiments since the first and second distances E1 and E2 may be substantially identical to one another or, in the alternative, the second distance E2 may be smaller than the first distance E1.

In example embodiments the first end member 2100 may further include a shelf member 2125. In example embodiments, the shelf member 2125 may resemble a substantially flat plat which may be oriented substantially perpendicular to the main member 2110. For example, the shelf member 2125 may extend along an entire length of the main member 2110 or may extend across only a portion of the main member 2110. In example embodiments, the main member 2110 and the shelf member 2125 may be formed from plates which are welded together to form a substantially contiguous structure. On the other hand, the main member 2110 may be formed from a metal plate which may have one end bent to form the shelf 2125. Further yet, the main member 2110 and the shelf member 2125 may be formed from a casting process and thus may be formed at the same time to form a continuous structure. The particular method of producing the main member 2110 and the shelf member 2125 is not meant to limit the invention, however, as one skilled in the art may readily be aware of several manufacturing processes which may result in a structure comprised of the main member 2110 and the shelf member 2130. In addition, the shelf member 2125, while shown as being generally perpendicular to the main member 2110 is not required to be perpendicular to the main member 2110 and may instead be inclined to the main member 2110 or may, in some other embodiments, be omitted in its entirety.

In example embodiments, the first end member 2100 may further include an attachment member 2130 configured to serve several functions. For example, in example embodiments, the attachment member 2130 may have a first side 2132 with a first plurality of holes 2134 formed therein. In example embodiments, the first plurality of holes 2134 may be threaded holes configured to receive screws that may be used to attach bearing 1031 to the attachment member 2130. For example, in example embodiments, the first plurality of holes 2134 may include four holes as illustrated in FIG. 11D. Although FIG. 11D illustrates the first plurality of holes 2134 as including four holes the number of holes is not intended to limit the invention as the first plurality of holes 2134 may include more than four holes or less than four holes. Furthermore, in some embodiments, only a single hole may be provided to attach the bearing 1031 thereto. Further yet, in some embodiments the first plurality of holes 2134 may be omitted in their entirety as the bearing 1031 may be attached to a different part of the first end member 2100. For example, in some embodiments, the bearing 1031 may be attached to the shelf member 2125. Further yet, rather than using screws and/or bolts to connect the bearing 1031 to the attachment member 2130 the bearing 1031 may be attached by different processes or structures, for example, welding or clipping.

In example embodiments, the attachment member 2130 may include a top surface 2140 configured to attach to the gap adjustment device 3000. For example, in example embodiments, the top surface 2140 may include a pair of threaded holes illustrated as 2142 and 2144, which may be configured to receive fasteners, for example, screws and/or bolts, that may attach the gap adjustment device 3000 to the attachment member 2130. In example embodiments, however, this is not intended to be a limiting feature since the attachment member 2130 may attach to the gap positioning device 3000 by another means such as, but not limited to, welding and/or clipping. As such, the top surface 2140 is not required to have a plurality of threaded holes. In addition, in other embodiments the gap adjustment device 3000 may attach to the attachment member 2130 by a single fastener or more than two fasteners. Thus, the number of holes provided in the top surface 2140 is not intended to limit example embodiments.

In example embodiments the attachment member 2130 may also include a pair of holes 2136 and 2138 which may extend through a width of the attachment member 2130. The pair of holes 2136 and 2138 may allow a member (or members) of the gap adjustment device 3000 to pass or attach therethrough. For example, the gap adjustment device 3000 may include a couple of biasing members which may have portions thereof extending through or attaching to the holes 2136 and 2138. In example embodiments, the holes 2136 and 2138 may or may not be threaded holes.

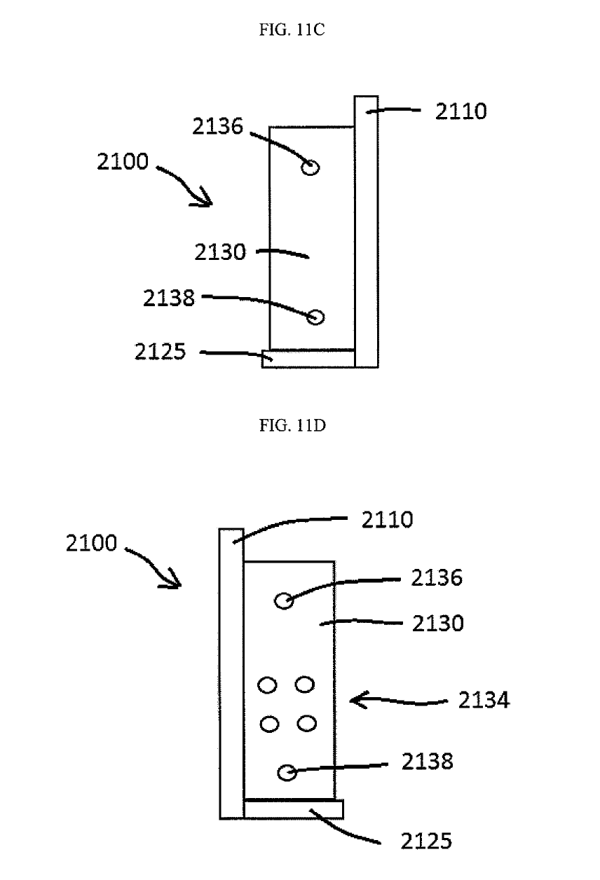

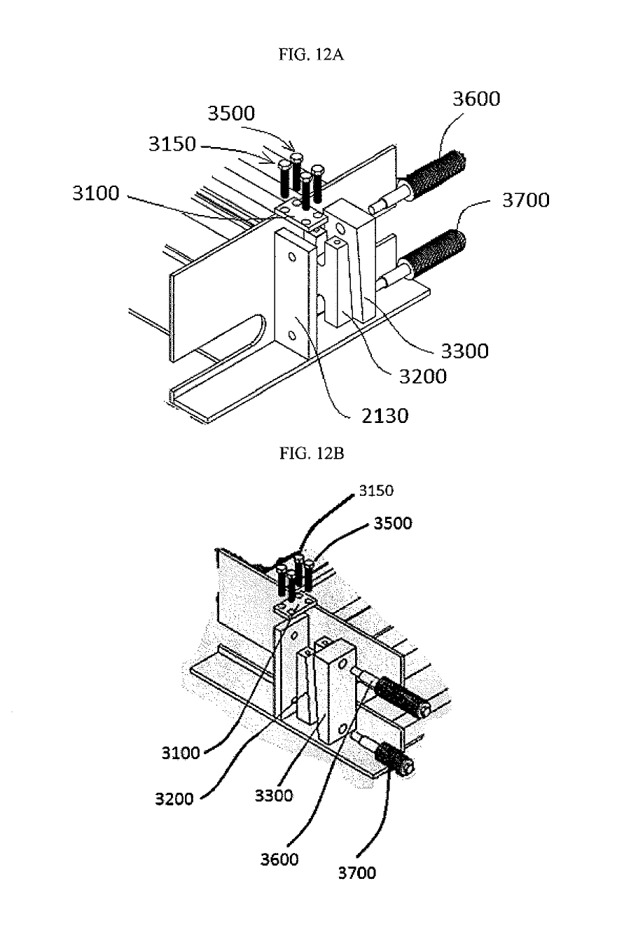

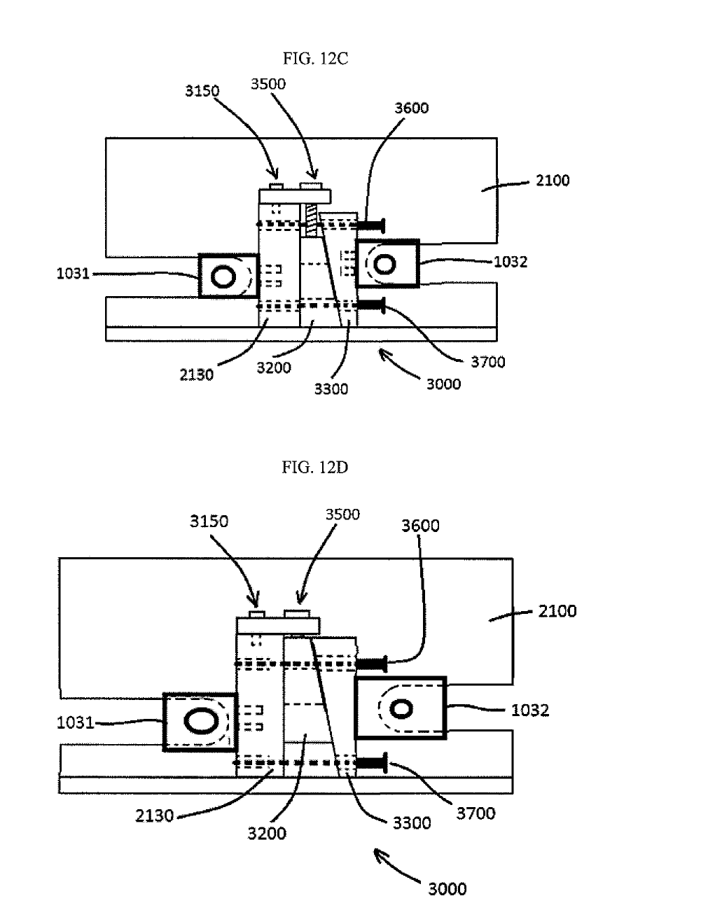

FIGS. 12A and 12B are exploded-perspective views of the gap adjustment device 3000. As shown in FIGS. 12A and 12B the gap adjustment device 3000 may include an attachment member 3100, a first wedge member 3200, a second wedge member 3300, first biasing member 3600 and a second biasing member 3700.

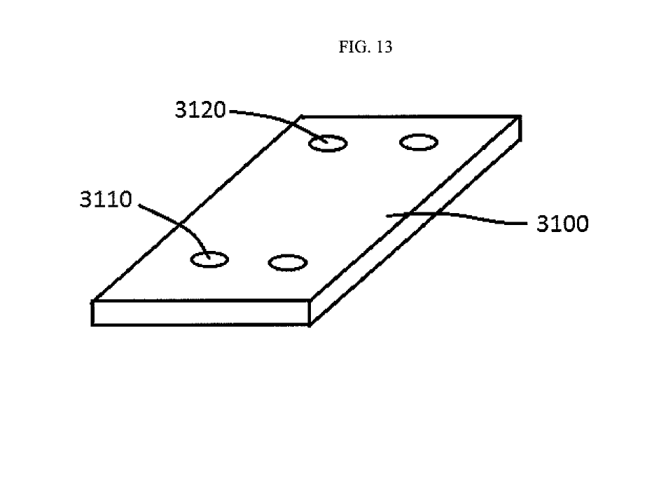

FIG. 13 is a perspective view of the attachment member 3100. As shown in FIGS. 12A, 12B, and 13 the attachment member 3100 may resemble a plate configured to attach to the top surface 2140 of the attachment member 2130. For example, in example embodiments the top surface 2140 of the attachment member 2130 may include a first threaded hole 2142 and a second threaded hole 2144 and the attachment member 3100 may resemble a plate having a first hole 3110 and a second hole 3120 which are alignable with the first threaded hole 2142 and the second threaded hole 2144 of the attachment member 2130. Once aligned, attachment members 3150, for example, screws and or bolts, (see FIG. 12B) may be used to attach the attachment member 3100 to the attachment member 2300. It should be understood that although the disclosed embodiment illustrates the attachment member 3100 being connected to the attachment member 2130 via two attachment members 3150, this is not intended to limit the invention. For example, in example embodiments, the attachment member 3100 may be attached to the attachment member 2130 via another means such as, but not limited to, welding. Further, in another embodiment, the attachment member 2130 and the attachment member 3100 may be integrally formed as through a casting process. Further yet only a single attachment member 3150 may be used to attach the attachment member 2130 to the attachment member 3100. In this latter embodiment only a single hole in each of the attachment member 3100 and the surface 2140 is necessary to attach the attachment member 2130 to the attachment member 3100.

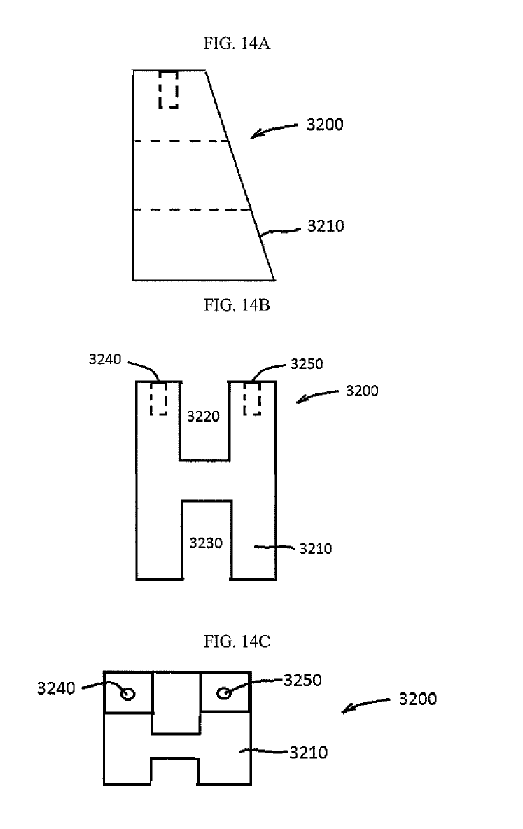

FIG. 14A illustrates a side view of the first wedge member 3200, FIG. 14B, illustrates another side view of the first wedge member 3200, and FIG. 14C illustrates a top view of the first wedge member 3200. As shown in FIG. 14A, the first wedge member 3200 may include inclined surfaces 3210. As will be explained shortly, the inclined surfaces 3210 may be configured to engage inclined surfaces of the second wedge member 3300 to exert a force thereon.

As shown in FIG. 14B, the first wedge member 3300 may include spaces 3220 and 3230 to allow portions of the biasing members 3600 and 3700 to pass therethrough. For example, when viewed from a side, the first wedge member 3300 may resemble an “H” to accommodate the first biasing member 3600 and a second biasing member 3700. Thus, in example embodiments, the “H” shape may be provided to allow the biasing members 3600 and 3700 to pass through when the gap adjustment device 3000 is assembled.

In example embodiments, as shown in at least FIG. 12B and FIG. 14C, a top of the first wedge member 3200 may include threaded holes which may be configured to engage threads of actuating members 3500. For example, the first wedge member 3200 may include a pair of threaded holes 3240 and 3250 and to accommodate a pair of threaded members (for example screws and/or bolts which are examples of actuating members 3500).

In example embodiments, the actuating members 3500 may be captured by holes of the attachment member 3100 in a manner that allows the actuating member 3500 to rotate, but not translate with respect to the attachment member 3100. For example, the actuating member 3500 may include a head arranged on one side of the attachment member 3100 and a collar on another side of the attachment member 3100 to prevent the actuating member 3500 from translating.

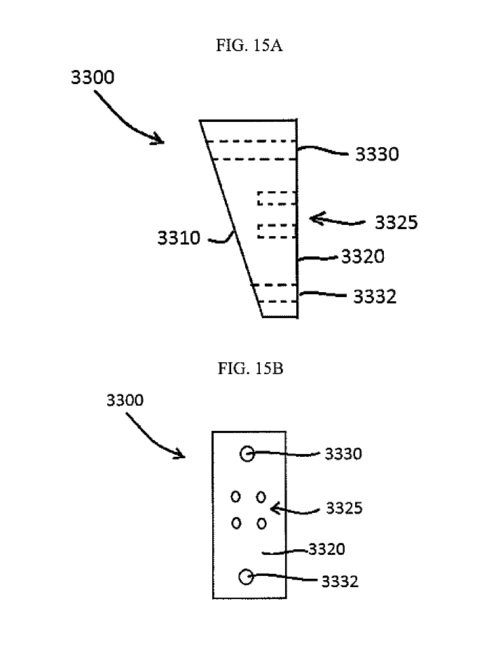

FIGS. 15A and 15B illustrate views of the second wedge member 3300. In example embodiments, the second wedge member 3300 may include an inclined surface 3310 configured to engage the inclined surface(s) of the first wedge member 3200. For example, the inclined surfaces 3310 and 3210 may have a same slope. In example embodiments, the second wedge member 3300 may also include a second surface 3320 which includes a plurality of threaded holes 3325. For example, as shown in FIG. 15B, the plurality of threaded holes 3325 may include four threaded holes which may be configured to receive threads of bolts that may be useable to connect bearing 1032 to the second wedge member 3300. The bearing 1032, as explained above, may be configured to support the second cylindrical roller 1022. Although FIG. 15B illustrates the plurality of holes 3325 as comprising four threaded holes, the invention is not limited thereto. For example, in another embodiment a single threaded hole may be provided to secure the bearing 1032 to the second wedge member 3300 for example, by a single bolt. In the alternative, example embodiments also allow for the plurality of holes 3325 to include only two holes, three holes, or more than four holes. In addition, the plurality of holes 3250 may be omitted and the bearing 1032 may be attached to the second wedge member 3300 by another means such as, but not limited to, welding.

In example embodiments, the wedge member 3300 may also include a first hole 3330 and a second hole 3332 through which portions of a first and second biasing members 3600 and 3700 may pass.

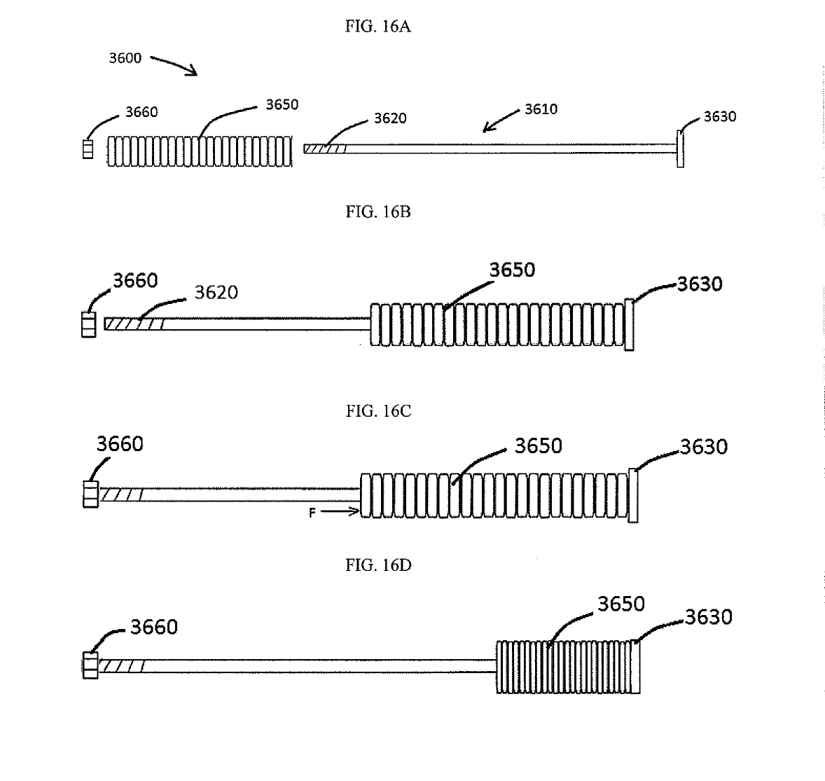

FIGS. 16A-16D are views of the biasing member 3600 usable with example embodiments. As shown in FIGS. 16A-16D the biasing member 3600 may include a rod-like body 3610 having a threaded region 3620 at one end and a cap 3630 on the other end. The biasing member 3600 may further include a biasing element 3650, for example, a spring, which may be on the body 3610. In example embodiments the body 3610 may be threaded through the hole 3330 of the second wedge member 3300, through the upper space 3220 of the first wedge member 3200 and through the hole 2136 of the attachment member 2100. In example embodiments, the body 3610 may be secured in place by a nut 3660 which bear, either directly or indirectly, against the first side 2132 of the attachment member 2300. In example embodiments the hole 3330 may be large enough to allow the rod-like body 3610 to pass therethrough but small enough to prevent the biasing element 3650 from passing through. As such, the biasing element 3650 may contact and press against, either directly or indirectly, the second side of the 3320 of the second wedge member 3300. In example embodiments, the second biasing member 3700 may be substantially identical to the first biasing member 3600, thus, a detailed description thereof is omitted for the sake of brevity.

FIGS. 12C and 12D are views of the assembled gap adjustment device 3000 on the first end member 2100. It is understood that another gap adjustment device 3000 is on the second end member 2200, however, description thereof is omitted for the sake of brevity.

FIG. 12C represents a state where attachment member 3100 is attached to the connecting member 2130 via attachment members 3150. Further, FIG. 12C represents a state where the first wedge member 3200 has threads engaged with threads of the actuating members 3500. Further yet, FIG. 12C represents a state where the inclined surfaces 3210 and 3310 are engaged with one another. Further yet, FIG. 12C represents the body 3610 of the first biasing member 3600 passing through the hole 3330 of the second wedge member 3300, an upper space 3220 of the first wedge member 3200, and the hole 2136 of the attachment member 2130. Further yet FIG. 12C represents the body of the second biasing member 3700 passing through the hole 3332 of the second wedge member 3300, a lower space 3230 of the first wedge member 3200, and the hole 2138 of the attachment member 2130. In this configuration the biasing elements of the first and second biasing devices 3600 and 3700 may exert a force on the second wedge member 3300. Finally, in this configuration, the first wedge member 3200 is shown distal from the attachment member 3100.

In example embodiments, if the actuators 3500 are rotated the first wedge member 3200 will move up and down due to the engagement between the threads of the actuators 3500 and the threaded holes 3240 and 3250 of the first wedge member 3200. For example, if the actuators 3500 are rotated in a first direction (for example, clockwise) the first wedge member 3200 may move towards the attachment member 3100 as shown in FIG. 12D. If, on the other hand, the actuators 3500 are rotated in a second direction (for example, counterclockwise) the first wedge member 3200 may move away from the attachment member 3100. As one skilled in the art would readily recognize, as the first wedge member 3200 moves towards and/or away from the attachment member 3100 the second wedge member 3300 will move away and/or towards the attachment member 2130.

As indicated above, the attachment member 2130 may be attached to the first bearing 1031 and the second wedge member 3300 may be attached to the bearing 1032. In example embodiments, because the first bearing 1031 may support the first roller 1020 and because the second bearing 1032 may support the second roller 1022, movement of the first and second bearings 1031 and 1032 via the gap adjustment device 3000 would move the roll 1020 and 1022 closer together or farther apart. As such, the gap G between the first and second rolls 1020 and 1022 may be adjusted by operation of the gap adjustment device 3000.

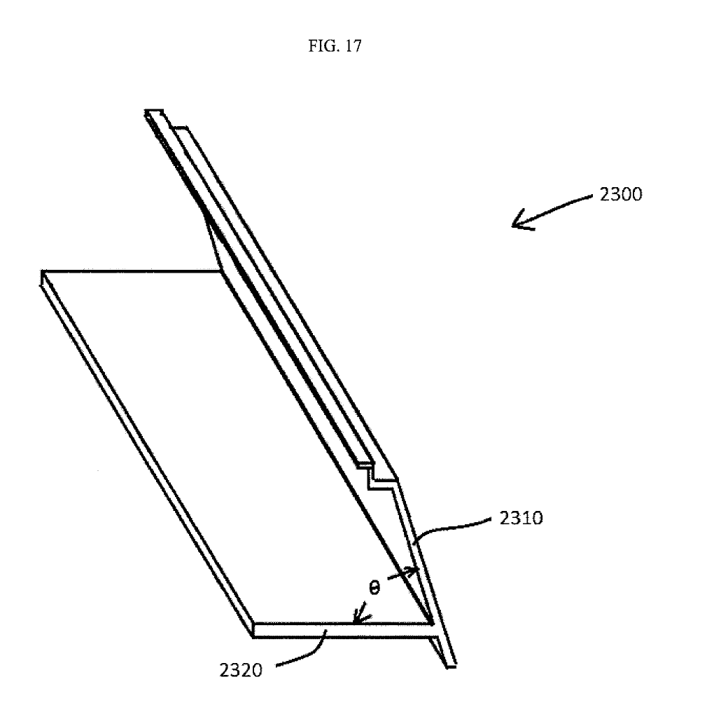

As alluded to earlier, the first end member 2100 and a second end member 2200 may be connected to one another by a plurality of connecting members. The first connecting member 2300, as shown in FIG. 17 may include a first member 2310 and a second member 2320. The first member 2210 and the second member 2320 may form an angle θ which may or may not be an acute angle. When formed as an acute angle, the first member 2310 may form a surface upon which cut material from a chopper may contact. The surface may aid in guiding the cut material cut by the first and second rollers 1020 and 1022. In example embodiments each of the first and second members 2310 and 2320 may resemble plates which may be attached to each other by a welding process. This, however, is not intended to be a limiting feature of example embodiments. For example, the first and second members 2310 and 2320 may be formed from a casting process and therefore may be a substantially integral structure.

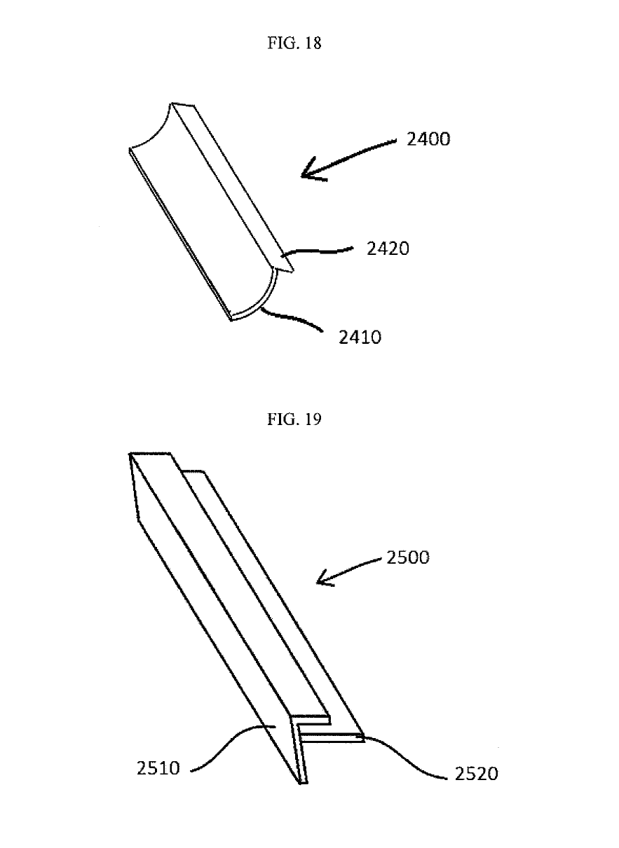

In example embodiments the second connecting member 2400 may also be comprised of a first member 2410 and a second member 2420. For example, as shown in FIG. 18, the second connecting member 2400 may have a first curved section 2410 and a flat second section 2420. In example embodiments the first curved section 2410 may partially enclose the first roller 1020 and, in cooperation with a shield 4000, may substantially enclose the first roller 1020. The second member 2420 may resemble a flat member which may aid in directing material to by the rolls 1020 and 1022 of the processor 1000.

In example embodiments the third connecting member 2500 may also be comprised of a first member 2510 and a second member 2520. For example, as shown in FIG. 19, the third connecting member 2500 may have a first section 2510 and a second section 2520. In example embodiments the first section 2510 may aid in directing a flow of chopped material away from the first and second rollers 1020 and 1022.

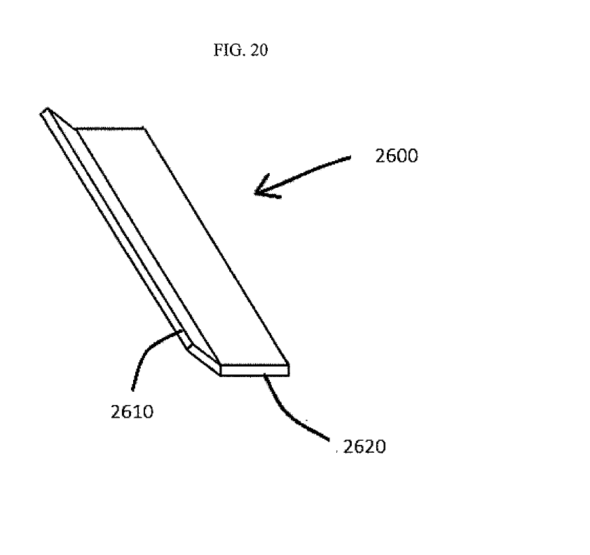

In example embodiments the fourth connecting member 2600 may also be comprised of a first member 2610 and a second member 2620. For example, as shown in FIG. 20, the fourth connecting member 2600 may have a first section 2610 and a second section 2620 each of which may be substantially flat members. In example embodiments the first section 2610 may aid in directing a flow of processed material out of the processor apparatus 1000.

Referring back to FIGS. 9 and 10, the processor apparatus 1000 may further include a first shield 4000 at least partially surrounding the first roller 1020 and a second shield 5000 at least partially surrounding the second roller 1022. In example embodiments, the first and second shields 4000 and 5000 may resemble curved surfaces. In example embodiments, a first side of the first shield 4000 may be hinge connected to the second member 2320 of the first connecting member 2300 and a second side of the first shield 4000 may contact with or connect with the first member 2410 of the second connecting member 2400. Similarly, a first side of the second shield 5000 may be hinge connected to the second member 2520 of the third cross member 2500 and a second side of the second shield 5000 may be configured to contact with or connect to the first member 2610 of the fourth connecting member 2600. For example, in example embodiments conventional hinges (not shown) may be used to connect the shields 4000 and 5000 to the first and third connecting members 2300 and 2500. Other elements, such as conventional plates, screws, or latches may be used to connect the first and second shields 4000 and 5000 to the second and fourth connecting members 2400 and 2600.

In example embodiments, the processor apparatus 1000 may further include pulleys 6000 and 6100. The belt pulley 6000 may be operatively connected to the first cylindrical roll 1020 and the belt pulley 6100 may be operatively connected to the second cylindrical roll 1022. In example embodiments, the pulleys 6000 and 6100 may transmit rotational energy to the first and second cylindrical rolls 1020 and 1022. In example embodiments, the belt pulleys 6000 and 6100 may be rotated under the influence of a belt of a machine, for example, a forage harvester.

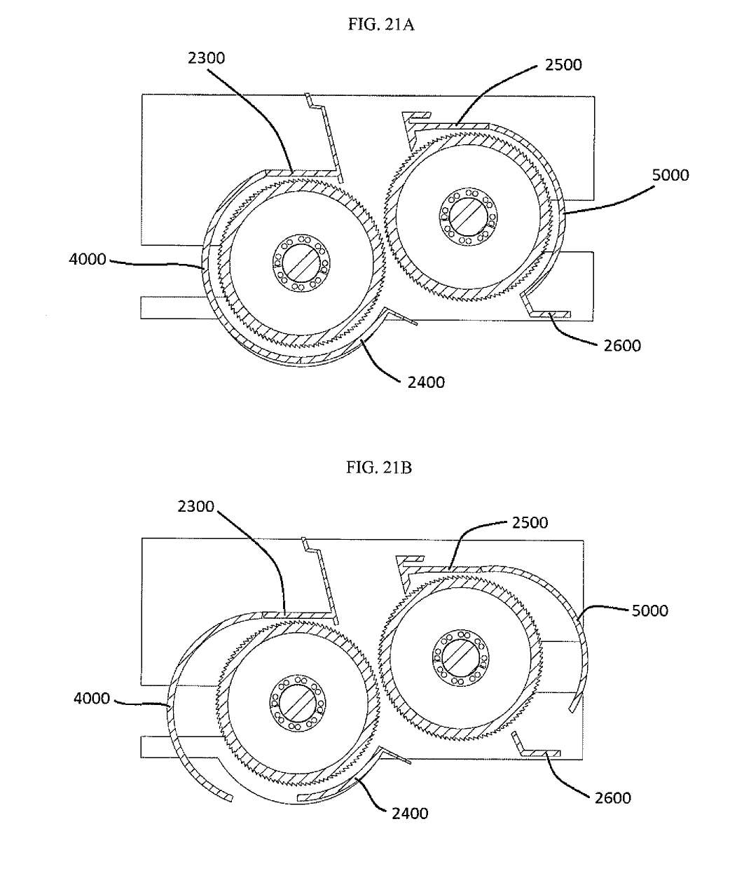

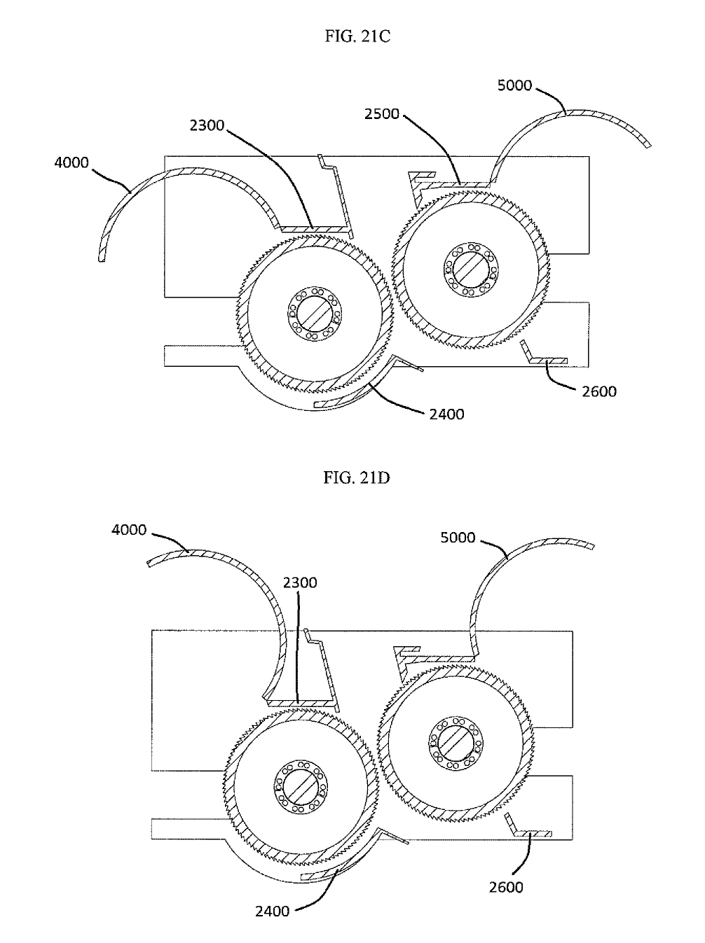

FIGS. 21A-21D illustrate various cross-sections of the processor apparatus 1000. In FIG. 21A, for example, the processor apparatus 1000 is illustrated with the shields 4000 and 5000 being in a closed configuration. In this configuration the rollers 1020 and 1022 are substantially covered by the shields 4000 and 5000. FIG. 21B illustrates the shields 4000 and 5000 separating from the second and fourth connecting member 2400 and 2600. FIGS. 21C and 21D illustrate further separation of the shields 4000 and 5000 from the second and fourth connecting member 2400 and 2600. In FIG. 21D, the bearings supporting the shafts of the rollers 1020 and 1022 may be uncoupled from the attachment members 2130 and the second wedge members 3300 allowing the rollers 1020 and 1022 to be removed from the frame 2000 for servicing and/or replacement.

Although FIGS. 21A-21D illustrate that the shields 4000 and 5000 may be hinge connected to the first and third cross members 2300 and 2500, this is not intended to be a limiting feature of example embodiments. For example, in another embodiment the first and second shields 4000 and 5000 may be removably connected to the first and third cross members 2300 and 2500 by using latches or some other fixing means such as, but not limited to, screws and or plates.

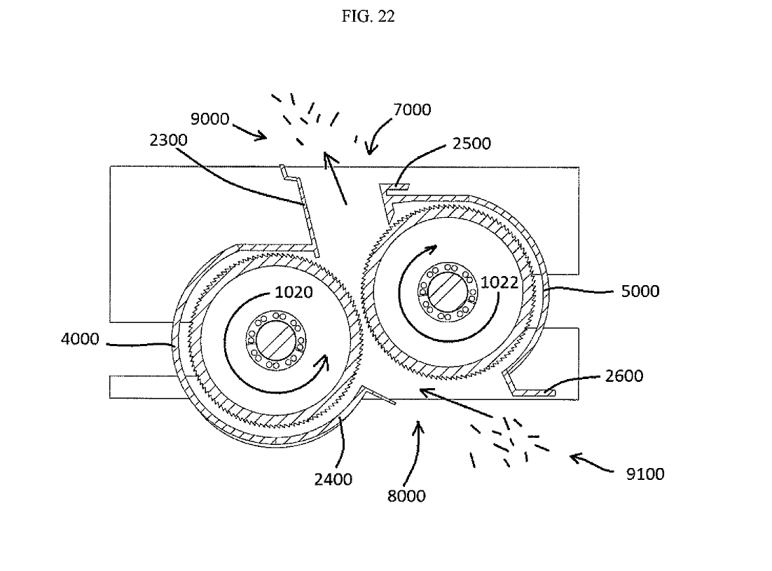

In example embodiments, the first cross member 2300 and the third cross member 2500 may be spaced apart from each other in a manner than allows the first member 2310 of the first cross member 2300 and the first member 2510 of the third cross member 2500 form an outlet 7000 to the processor apparatus 1000. Similarly, in example embodiments, the second cross member 2400 and the fourth cross member 2600 may be spaced apart from each other to form an inlet 8000 of the processor apparatus 1000. For example, as shown in FIG. 22 chopped material 9100 may be fed into the processor apparatus 1000 via the inlet 8000 formed by the second and fourth cross members 2400 and 2600. The chopped material 9100 may be shredded by the cylindrical rolls 1020 and 1022 to obtain a product having the previously described characteristics. After the chopped material is processed (for example, shredded) by the cylindrical rolls 1020 and 1022, the shredded product 9000 may exit the processor apparatus 1000 via the outlet formed by the first and third cross members 2300 and 2500.

It should be appreciated that in the foregoing description and appended claims, that the terms “substantially” and “approximately,” when used to modify another term, mean “for the most part” or “being largely but not wholly or completely that which is specified” by the modified term.

It should also be appreciated from the foregoing description that, except when mutually exclusive, the features of the various embodiments described herein may be combined with features of other embodiments as desired while remaining within the intended scope of the disclosure.

With respect to the above described invention, it is to be realized that the optimum dimensional relationships for the parts of the disclosed embodiments and implementations, to include variations in size, materials, shape, form, function and manner of operation, assembly and use, are deemed readily apparent and obvious to one skilled in the art in light of the foregoing disclosure, and all equivalent relationships to those illustrated in the drawings and described in the specification are intended to be encompassed by the present disclosure.

Therefore, the foregoing is considered as illustrative only of the principles of the disclosure. Further, since numerous modifications and changes will readily occur to those skilled in the art, it is not desired to limit the disclosed subject matter to the exact construction and operation shown and described, and accordingly, all suitable modifications and equivalents may be resorted to that which falls within the scope of the claims.

What is claimed is:

1. A processing apparatus comprised of:
a first cylindrical roll;
a second cylindrical roll spaced apart from the first cylindrical roll;
a frame supporting the first and second cylindrical rolls; and
a gap adjusting device configured to control a gap between the first cylindrical roll and the second cylindrical roll, wherein the first and second cylindrical rolls have teeth configured to shred plant material.

2. The processing apparatus of claim 1, wherein
the gap adjusting device includes a first wedge, a second wedge, an actuator, and at least one biasing member and the second cylindrical roll is attached to the second wedge and the first wedge is attached to the frame.

3. The processing apparatus of claim 2, wherein the actuator is a threaded member having threads engaging threads of a threaded hole in the first wedge.

4. The processing apparatus of claim 3, wherein the at least one biasing member includes a body attached to the frame and a biasing element configured to exert a force on the second wedge.

5. The processing apparatus of claim 4, wherein the first wedge is sandwiched between a portion of the frame and the second wedge.

6. The processing apparatus of claim 1, wherein the frame includes a first end member, a second end member, and a plurality of connecting members connecting the first end member to the second end member.

7. The processing apparatus of claim 6, wherein the plurality of connecting members includes a first connecting member, a second connecting member, a third connecting member, and a fourth connecting member wherein the first and third connecting members are spaced apart to form an inlet of the processing apparatus and the second and fourth connecting members are spaced apart to form an exit of the processing apparatus.

8. The processing apparatus of claim 7, further comprising:
a first shield configured to attach to the first and second connecting members; and
a second shield configured to attach to the third and fourth connecting members.

9. The processing apparatus of claim 8, wherein the first shield is hinge connected to the first connecting member and the second shield is hinge connected to the third connecting member.

10. The processing apparatus of claim 8, wherein the first shield and the second shield
